(19) United States
(12) Patent Application Publication
(10) Pub. No.: US 2025/0336997 A1
(43) Pub. Date: Oct. 30, 2025

(54) FUEL CELL MANUFACTURING DEVICE AND FUEL CELL MANUFACTURING METHOD

(71) Applicant: TOYOTA JIDOSHA KABUSHIKI KAISHA, Toyota-shi (JP)

(72) Inventors: Kazuya OGURA, Toyota-shi (JP); Tatsuo HOSHINO, Anjo-shi (JP); Michihisa MOCHIZUKI, Toyota-shi (JP); Yuta OTSUKA, Toyota-shi (JP)

(73) Assignee: TOYOTA JIDOSHA KABUSHIKI KAISHA, Toyota-shi (JP)

(21) Appl. No.: 19/041,177

(22) Filed: Jan. 30, 2025

(30) Foreign Application Priority Data
Apr. 26, 2024 (JP) 2024-072321

(51) Int. Cl. H01M 8/1004; H01M 8/0286; H01M 8/2483

(52) U.S. Cl. CPC H01M 8/1004; H01M 8/0286; H01M 8/2483

(57) ABSTRACT

A fuel cell manufacturing device includes: a first press die; and a second press die configured to press, between the first press die and the second press die, a stack of a fuel cell that includes a membrane electrode assembly, an adhesive, and a separator to bond the membrane electrode assembly and the separator via the adhesive. Either or both of the first press die and the second press die include a first portion and a second portion, the first portion being configured to press a peripheral edge portion of a power generation area of the fuel cell, and the second portion being configured to press a peripheral edge portion of a manifold of the fuel cell.

### CROSS-REFERENCE TO RELATED APPLICATION

This application claims priority to Japanese Patent Application No. 2024-072321 filed on Apr. 26, 2024, incorporated herein by reference in its entirety.

### BACKGROUND

### 1. Technical Field

The present disclosure relates to fuel cell manufacturing devices and fuel cell manufacturing methods.

### 2. Description of Related Art

A method for manufacturing a fuel cell using a hot press device is known in the art (e.g., Japanese Unexamined Patent Application Publication No. 2020-013753 (JP 2020-013753 A)).

### SUMMARY

Conventionally, press dies specially designed for fuel cells are used in a press process. Accordingly, when manufacturing a plurality of types of fuel cells in one production line, the press die needs to be exchanged, and the plurality of types of fuel cells therefore cannot be efficiently manufactured.

The present disclosure can be implemented in the following forms.

A first aspect of the present disclosure provides a fuel cell manufacturing device.

This fuel cell manufacturing device includes:
a first press die; and
a second press die configured to press, between the first press die and the second press die, a stack of a fuel cell that includes a membrane electrode assembly, an adhesive, and a separator to bond the membrane electrode assembly and the separator via the adhesive,
Either or both of the first press die and the second press die include a first portion and a second portion. The first portion is configured to press a peripheral edge portion of a power generation area of the fuel cell. The second portion is configured to press a peripheral edge portion of a manifold of the fuel cell.
   With the fuel cell manufacturing device of this aspect, the first press die and the second press die can press a position where the adhesive is present in all of a plurality of types of fuel cells. This reduces the frequency of exchanging the first press die and the second press die, so that the plurality of types of fuel cells can be efficiently manufactured.
   In the fuel cell manufacturing device of the above aspect,
the first portion and the second portion may be thicker than a portion of the stack that includes the power generation area.
   Since the fuel cell manufacturing device of this aspect is configured not to press the power generation area, the power generation area is less likely to be damaged by pressing.
   In the fuel cell manufacturing device of the above aspect,
either or both of the first press die and the second press die may include a third portion that overlaps the power generation area, and may be configured in such a manner that a thickness of the third portion is changeable.
   With the fuel cell manufacturing device of this aspect, the third portion can press a position that cannot be pressed by the first portion or the second portion. This reduces insufficient pressing at any position.
   In the fuel cell manufacturing device of the above aspect,
the first press die and the second press die may be used to preliminarily attach the membrane electrode assembly and the separator together.
   The fuel cell manufacturing device of this aspect can efficiently perform the preliminary attachment.
   A second aspect of the present disclosure provides a fuel cell manufacturing method.
   This fuel cell manufacturing method includes:
preparing a stack of a fuel cell that includes a membrane electrode assembly, an adhesive, and a separator; and
pressing the stack between a first press die and a second press die to bond the membrane electrode assembly and the separator via the adhesive.
   Either or both of the first press die and the second press die include a first portion and a second portion. The first portion is configured to press a peripheral edge portion of a power generation area of the fuel cell. The second portion is configured to press a peripheral edge portion of a manifold of the fuel cell.
   With the fuel cell manufacturing method of this aspect, the first press die and the second press die can press a position where the adhesive is present in all of a plurality of types of fuel cells. This reduces the frequency of exchanging the first press die and the second press die, so that the plurality of types of fuel cells can be efficiently manufactured.
   The present disclosure can also be implemented in various forms other than the fuel cell manufacturing device and the fuel cell manufacturing method. For example, the present disclosure can be implemented in forms such as a press device and a press method.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory view showing a configuration of a fuel cell;

FIG. 2 is a sectional view taken along line II-II in FIG. 1;

FIG. 3 is an explanatory view showing a configuration of a press device;

FIG. 4 is a plan view of a press die;

FIG. 5 is an illustration showing a fuel cell manufacturing method; and

FIG. 6 is a plan view of a press die of another embodiment.

### DETAILED DESCRIPTION OF EMBODIMENTS

### A. Embodiment

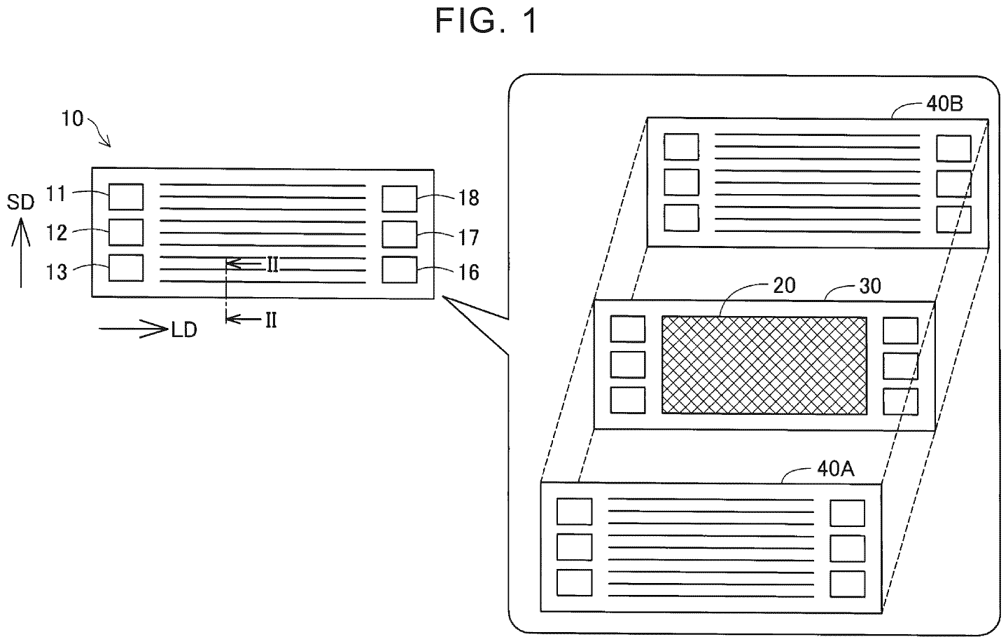

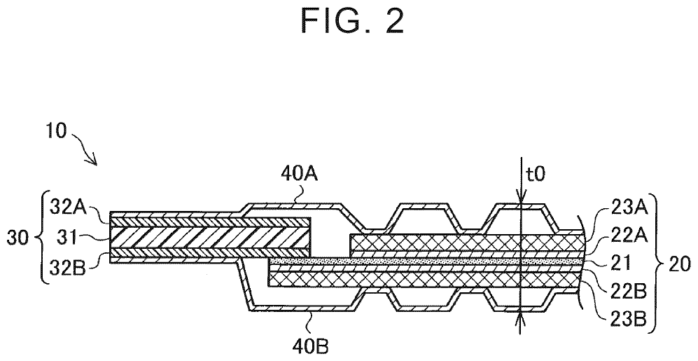

FIG. 1 is an explanatory diagram illustrating a configuration of a fuel cell 10 according to an embodiment of the present disclosure. FIG. 2 is a sectional view taken along line II-II in FIG. 1. In the present embodiment, the fuel cell 10 is a polymer electrolyte fuel cell. However, the fuel cell 10 may be a fuel cell other than a polymer electrolyte fuel cell. A single fuel cell 10 may be referred to as a single cell, and a stacked body in which a plurality of single cells is stacked may be referred to as a stack. In the present disclosure, unless otherwise stated, the term fuel cell means a single cell.

As illustrated in FIG. 1, the fuel cell 10 includes a membrane electrode assembly 20, a resin sheet 30, and two separators 40A, 40B. The fuel cell 10 generates electricity by an electrochemical reaction between air supplied as a cathode gas and hydrogen supplied as an anode gas. In the present embodiment, the fuel cell 10 has a rectangular shape in plan view. Manifolds 11 to 13 and 16 to 18 through which the anode gas, the cathode gas, and the coolant flow are provided at both ends in the longitudinal LD of the fuel cell 10. The membrane electrode assembly 20 has a rectangular shape in plan view. The resin sheet 30 is formed in a rectangular frame shape in plan view, and is disposed so as to surround the outer periphery of the membrane electrode assembly 20. An inner peripheral portion of the resin sheet 30 is bonded to an outer peripheral portion of the membrane electrode assembly 20. The two separators 40A, 40B are arranged so as to sandwich the membrane electrode assembly 20 and the resin sheet 30. The separators 40A, 40B are formed in a rectangular shape in plan view. The separators 40A, 40B are bonded to the resin sheet 30. The resin sheet 30 and the separators 40A, 40B have through holes constituting the manifolds 11 to 13 and 16 to 18.

As illustrated in FIG. 2, the membrane electrode assembly 20 includes an electrolyte membrane 21, electrode catalyst layers 22A, 22B provided on both surfaces of the electrolyte membrane 21, and gas diffusion layers 23A, 23B provided on the electrode catalyst layers 22A, 22B. However, the membrane electrode assembly 20 may not include the gas diffusion layers 23A, 23B. The electrode catalyst layer 22A is a cathode electrode, and the electrode catalyst layer 22B is an anode electrode. The electrolyte membrane 21 is composed of, for example, a fluororesin-based ion exchange membrane. The electrode catalyst layers 22A, 22B are formed of, for example, a carbon support on which a platinum catalyst is supported. The gas diffusion layers 23A, 23B are made of, for example, carbon paper.

The inner peripheral portion of the resin sheet 30 is bonded to the outer peripheral portion of the membrane electrode assembly 20 by, for example, a photocurable adhesive. The resin sheet 30 includes a core layer 31 and adhesive layers 32A, 32B provided on both surfaces of the core layer 31. The core-layer 31 is made of, for example, polyethylene naphthalate (PEN). The adhesive layers 32A, 32B are composed of, for example, a modified olefin-based hot-melt adhesive. The melting point of the core layer 31 is preferably higher than the melting point of the adhesive layers 32A, 32B. The tensile strength of the core layer 31 is preferably higher than the tensile strength of the adhesive layers 32A, 32B. The hardness of the core layer 31 is preferably higher than the hardness of the adhesive layers 32A, 32B.

The separators 40A, 40B are bonded to the resin sheet 30 by the adhesive layers 32A, 32B. The separators 40A, 40B are made of, for example, a titanium alloy. The separators 40A, 40B are provided with irregularities by, for example, press forming. A flow path through which the cathode gas flows is formed between the separator 40A on the cathode side and the membrane electrode assembly 20 due to the above-described irregularities, and a flow path through which the anode gas flows is formed between the separator 40B on the anode side and the membrane electrode assembly 20 due to the above-described irregularities.

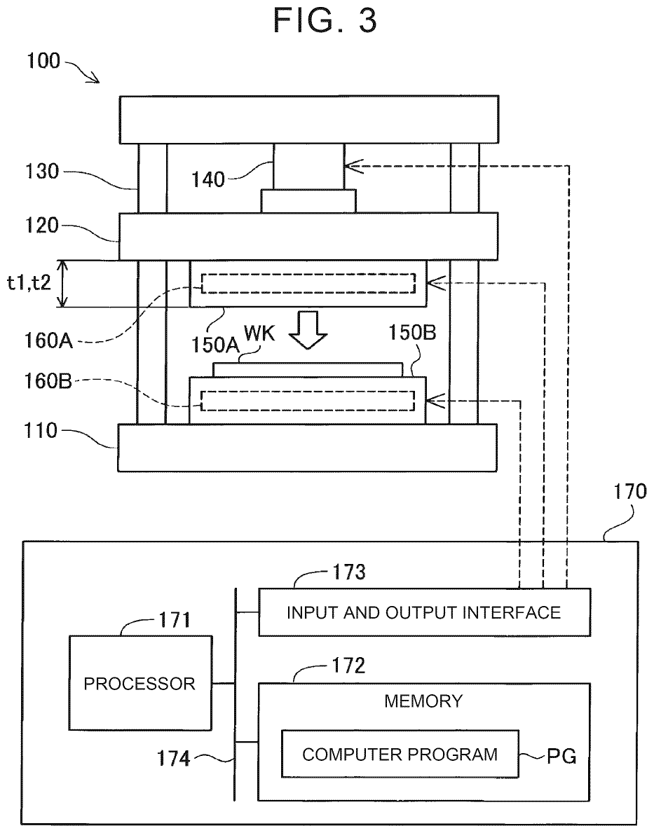

FIG. 3 is an illustration showing a configuration of the press device 100 according to the present embodiment. The press device 100 corresponds to the “fuel cell manufacturing device” in the present disclosure. The press device 100 is used to join the two separators 40A, 40B and the membrane electrode assembly 20 via the adhesive layers 32A, 32B of the resin sheet 30. The press device 100 includes a fixed platen 110, a movable platen 120, a guide portion 130, a drive unit 140, a first press die 150A, a second press die 150B, a first heater 160A, a second heater 160B, and a control unit 170.

The fixed platen 110 and the movable platen 120 are arranged to face each other. In the present embodiment, the movable platen 120 is disposed on the fixed platen 110. However, the movable platen 120 may be disposed under the fixed platen 110. The movable platen 120 is configured to be movable up and down along the guide portion 130. The vertical position of the movable platen 120 is changed by the drive unit 140. The drive unit 140 is constituted by, for example, an actuator such as an electric cylinder or a hydraulic cylinder. Note that the position of the fixed platen 110 may not be fixed, and both the position of the fixed platen 110 and the position of the movable platen 120 may be changed by the drive unit 140.

The first press die 150A is mounted on the movable platen 120, and the second press die 150B is mounted on the fixed platen 110. The first press die 150A and the second press die 150B are arranged so as to face each other with the first press die 150A mounted on the movable platen 120 and the second press die 150B mounted on the fixed platen 110. In the present embodiment, the first press die 150A is configured in such a manner that the thickness of part of the first press die 150A is changeable, and the second press die 150B is configured in such a manner that the thickness of part of the second press die 150B is changeable. However, either or both of the first press die 150A and the second press die 150B may not be configured in such a manner that its (their) thickness is changeable. A specific configuration of the first press die 150A and the second press die 150B will be described later. In the following explanation, the first press die 150A and the second press die 150B are sometimes simply referred to as a press die 150 when they are described without being particularly distinguished from each other.

The first heater 160A is a heater that heats the first press die 150A, and is provided in either or both of the movable platen 120 and the first press die 150A. The second heater 160B is a heater that heats the second press die 150B, and is provided in either or both of the fixed platen 110 and the second press die 150B.

The control unit 170 controls the drive unit 140, the first heater 160A, and the second heater 160B. The control unit 170 includes a computer including a processor 171, a memory 172, an input/output interface 173, and an internal bus 174. The processor 171, the memory 172, and the input/output interface 173 are bidirectionally communicably connected to each other via an internal bus 174. The drive unit 140, the first heater 160A, and the second heater 160B are connected to the input and output interface 173 via wired communication or wireless communication. The processor 171 performs various functions including a function of changing the position of the movable platen 120 by the drive unit 140 by executing a computer program PG stored in advance in the memory 172, a function of heating the first press die 150A by the first heater 160A, and a function of heating the second press die 150B by the second heater 160B.

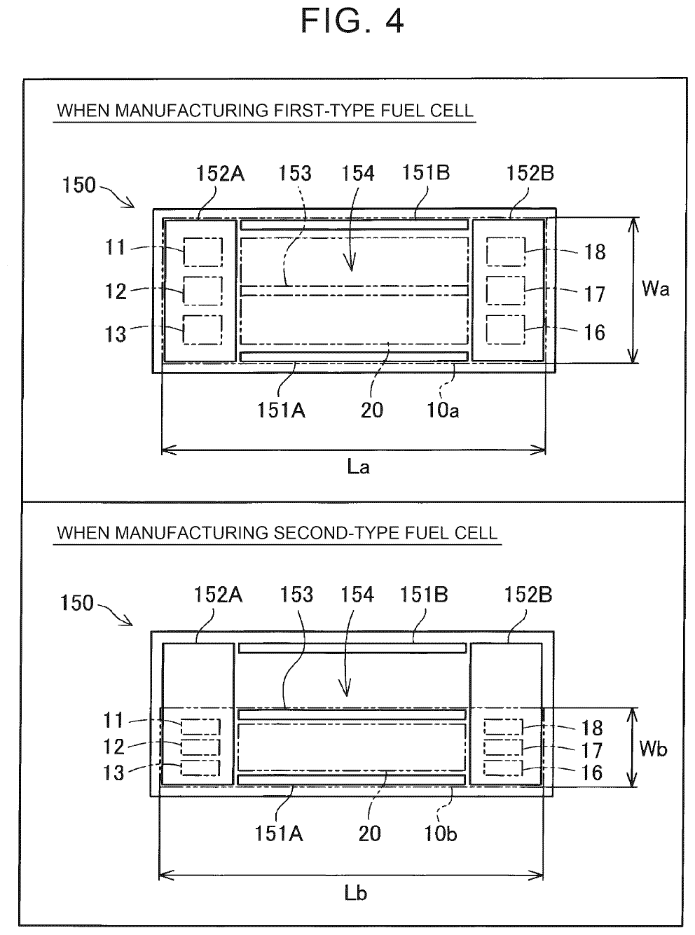

FIG. 4 is an illustration showing a configuration of the press die 150 according to the present embodiment. The press die 150 is used for manufacturing a plurality of types of fuel cells 10a, 10b. In the following explanation, the fuel cell 10a is referred to as a first-type fuel cell 10a, and a fuel cell 10b of a type different from the first-type fuel cell 10a is referred to as a second-type fuel cell 10b. In the present embodiment, the length Lb of the second-type fuel cell 10b is the same as the length La of the first-type fuel cell 10a, but the width Wb of the second-type fuel cell 10b is narrower than the width Wb of the first-type fuel cell 10a. The components of the first-type fuel cell 10a and the second-type fuel cell 10b are the same as the components of the fuel cell 10 shown in FIG. 1.

The press die 150 has two first portions 151A, 151B, two second portions 152A, 152B, a third portion 153, and a fourth portion 154. The two first portions 151A, 151B are spaced apart. The two second portions 152A, 152B are spaced apart so as to sandwich the two first portions 151A, 151B. The direction from one second portion 152A toward the other second portion 152B is perpendicular to the direction from one first portion 151A toward the other first portion 151B. The third portion 153 is disposed between the two first portions 151A, 151B and between the two second portions 152A, 152B. The fourth portion 154 is a portion other than the first portions 151A, 151B, the second portions 152A, 152B, and the third portion 153. The thickness t1 of the first portions 151A, 151B and the thickness t2 of the second portions 152A, 152B are larger than the thickness to of the portions of the fuel cells 10a, 10b that include the power generation area. The power generation area is an area in which the membrane electrode assembly 20 is disposed.

The third portion 153 is configured in such a manner that the thickness of the third portion 153 is changeable. In the present embodiment, the thickness of the third portion 153 is changed by attaching and detaching the attachment to and from the press die body. In the present embodiment, either or both of the attachment and the press die body include a magnet, and the attachment is fixed to the press die body by the magnetic force of the magnet. However, the attachment may not be fixed to the press die body by a magnet, but may be fixed to the press die body by, for example, a screw. If the separators 40A, 40B are made of a material that is attracted to the magnet, the attachment is preferably fixed to the press die body by means other than the magnet. The attachment may be attached and detached manually by an operator, but is preferably automated by a robot arm or the like.

In the present embodiment, the surfaces of the first portions 151A, 151B on the fuel cell 10a, 10b side and the surfaces of the second portions 152A, 152B on the fuel cell 10a, 10b side are located on the same plane. The surfaces of the first portions 151A, 151B on the fuel cell 10a, 10b side and the surfaces of the second portions 152A, 152B on the fuel cell 10a, 10b side protrude toward the fuel cell 10a, 10b side from the surface of the third portion 153 on the fuel cell 10a, 10b side and the surface of the fourth portion 154 on the fuel cell 10a, 10b side when the attachment is not mounted. The surface of the third portion 153 on the fuel cell 10a, 10b side and the surface of the fourth portion 154 on the fuel cell 10a, 10b side when the attachment is not attached are located on the same plane. The surface of the third portion 153 on the fuel cell 10a, 10b side when the attachment is mounted is located on the same plane as the surfaces of the first portions 151A, 151B on the fuel cell 10a, 10b side and the surfaces of the second portions 152A, 152B on the fuel cell 10a, 10b side.

When manufacturing the first-type fuel cell 10a, the two first portions 151A, 151B are in contact with the peripheral edge portion of the power generation area of the first-type fuel cell 10a, and the two second portions 152A, 152B are in contact with the peripheral edge portion of the manifolds of the first-type fuel cell 10a. The peripheral edge portion of the power generation area is a portion around the power generation area, in other words, a portion around the membrane electrode assembly 20. The manifold peripheral edge portion is the portion around the manifolds 11 to 13, 16 to 18. When the first-type fuel cell 10a is manufactured, the attachment is removed from the press die body, and the third portion 153 overlaps the first-type fuel cell 10a in a plan view, but does not contact the first-type fuel cell 10a.

When manufacturing the second-type fuel cell 10b, one first portion 151A is in contact with the peripheral edge portion of the power generation area of the second-type fuel cell 10b, but the other first portion 151B is not in contact with the second-type fuel cell 10b. When manufacturing the second-type fuel cell 10b, part of each second-portion 152A, 152B contacts the manifold peripheral edge portion of the second-type fuel cell 10b, but a remaining part of each second portion 152A, 152B does not contact the second-type fuel cell 10b. When manufacturing the second-type fuel cell 10b, an attachment is attached to the press die body. The thickness of the third portion 153 at the time of manufacturing the second-type fuel cell 10b is larger than the thickness of the third portion 153 at the time of manufacturing the first-type fuel cell 10a, and the third portion 153 contacts the peripheral edge portion of the power generation area of the second-type fuel cell 10b.

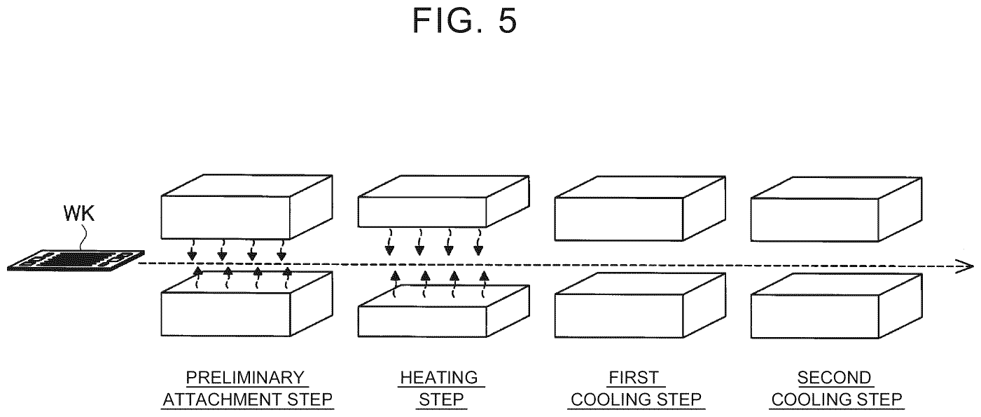

FIG. 5 is an illustration showing a method for manufacturing the fuel cell 10 according to the present embodiment. The method for manufacturing the fuel cell 10 includes a preliminary attachment step, a heating step, a first cooling step, and a second cooling step. Prior to the preliminary attachment step, a stack in which the membrane electrode assembly 20 and the resin sheet 30 are disposed between the two separators 40A, 40B is prepared as a workpiece WK. The membrane electrode assembly 20 and the resin sheet 30 are bonded in advance. The workpiece WK is subjected to a preliminary attachment step, a heating step, a first cooling step, and a second cooling step in this order, whereby the fuel cell 10 is manufactured. Between the respective steps, the workpiece WK is conveyed by, for example, a pallet.

In the preliminary attachment step, the separators 40A, 40B are preliminarily attached to the membrane electrode assembly 20 and the resin sheet 30 by hot pressing using the press device 100 shown in FIG. 3. Specifically, the workpiece WK is sandwiched between the first press die 150A and the second press die 150B, and the workpiece WK is heated while being pressed, whereby the separators 40A, 40B are brought into close contact with the adhesive layers 32A, 32B of the resin sheet 30 and at least part of the adhesive layers 32A, 32B is melted. In the present embodiment, the first press die 150A and the second press die 150B in the preliminary attachment step are higher than the melting point of the adhesive layers 32A, 32B. The melting point of the adhesive layers 32A, 32B is about 160 degrees Celsius, and the temperatures of the first press die 150A and the second press die 150B in the preliminary attachment step are maintained at around 200 degrees Celsius.

In the heating step, by heating the workpiece WK, the temperature of the adhesive layers 32A, 32B is raised to a temperature equal to or higher than the melting point of the adhesive layers 32A, 32B, and the adhesive layers 32A, 32B is sufficiently melted. The method for heating the workpiece WK in the heating step is not particularly limited. For example, the workpiece WK may be heated by a heating furnace, or the workpiece WK may be heated by irradiating the workpiece WK with an electromagnetic wave such as a microwave. The heating step may be integrated with the preliminary attachment step. That is, the heating step may be performed using the press device 100.

In the first cooling step, the workpiece WK is cooled by a cooling press, whereby the adhesive force of the adhesive layers 32A, 32B is developed. Specifically, the workpiece WK is sandwiched by the press die for a predetermined period of time while keeping the temperature of the press die for the cold press at a temperature before and after the crystallization temperature of the adhesive layers 32A, 32B so as to obtain the desired adhesive strength of the adhesive layers 32A, 32B and the desired thickness of the workpiece WK. In the present embodiment, the crystallization temperature of the adhesive layers 32A, 32B is about 100 degrees Celsius, and the temperature of the press die in the first cooling step is maintained at about 100 degrees Celsius. In the first cooling step, the basic configuration is the same as that of the press device 100 shown in FIG. 3, but a press device having a cooling function can be used instead of the heating function.

In the second cooling step, the workpiece WK is cooled by a cooling press to cool the workpiece WK to a temperature that can be touched by hand. Specifically, the workpiece WK is held by the press die for a predetermined period of time while the temperature of the press die for the cold press is maintained at, for example, a temperature of about 50 degrees Celsius. In the second cooling step, the basic configuration is the same as that of the press device 100 shown in FIG. 3, but a press device having a cooling function can be used instead of the heating function.

According to the press device 100 of the present embodiment described above, the press die 150 can be used for both the production of the first-type fuel cell 10a and the production of the second-type fuel cell 10b without replacing the press die 150. Specifically, a position where the adhesive layers 32A, 32B are provided in both of the first-type fuel cell 10a and the second-type fuel cell 10b can be pressed by one first portion 151A and both of the second portions 152A, 152B. In the related art, since the replacement of the press die for the hot press is required at the time of manufacturing the first-type fuel cell 10a and at the time of manufacturing the second-type fuel cell 10b, the time for lowering the temperature of the press die, the time for replacing the press die, and the time for raising the temperature of the press die are required, so that the first-type fuel cell 10a and the second-type fuel cell 10b cannot be efficiently manufactured in one production line. However, in the present embodiment, even if the press die 150 is not replaced, the press die 150 can be used for both the production of the first-type fuel cell 10a and the production of the second-type fuel cell 10b, and thus the first-type fuel cell 10a and the second-type fuel cell 10b can be efficiently manufactured in one production line by reducing the frequency of replacement of the press die 150.

Although the adhesive layers 32A, 32B are not provided in the second-type fuel cell 10b, the position where the adhesive layers 32A, 32B are provided in the first-type fuel cell 10a can be pressed by the other first portion 151B. Although the adhesive layers 32A, 32B are not provided in the first-type fuel cell 10a, the position where the adhesive layers 32A, 32B are provided in the second-type fuel cell 10b can be pressed by the third portion 153 whose thickness is changeable by attaching or detaching the attachment. Therefore, it is possible to reduce insufficient pressing of the adhesive layers 32A, 32B both at the time of manufacturing the first-type fuel cell 10a and at the time of manufacturing the second-type fuel cell 10b.

### B. Other Embodiments

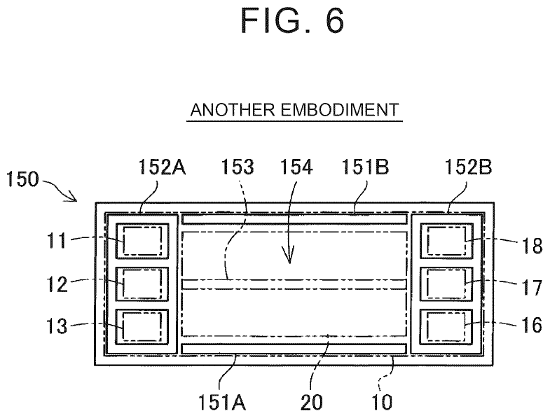

(B1) FIG. 6 is an illustration showing a configuration of a press die 150 according to another embodiment. In the above embodiment, the press die 150 is configured in a planar shape such that the second portions 152A, 152B cover the manifolds 11 to 13 and 16 to 18 of the fuel cell 10. Therefore, a wide range can be heated. On the other hand, in other embodiments, as shown in FIG. 6, the press die 150 may be formed in a frame shape or a line shape so that the second portions 152A, 152B do not cover the manifolds 11 to 13 and 16 to 18. In the above embodiment, the first portions 151A, 151B are configured to be linear, but in other embodiments, the first portions 151A, 151B may be configured to be planar.
(B2) In the above embodiment, the fuel cell 10 has a rectangular planar shape. In contrast, in other embodiments, the planar shape of the fuel cell 10 is not limited to a rectangular shape, and may be, for example, a polygon other than a rectangular shape, or may be a circular shape, an oval shape, or the like. In this case, the planar shape of the first portions 151A, 151B, the second portions 152A, 152B, and the third portion 153 of the press die 150 may be a shape corresponding to the planar shape of the fuel cell 10.
(B3) In the above embodiment, the third portion 153 is configured to press the peripheral edge portion of the power generation area of the second-type fuel cell 10b. On the other hand, in other embodiments, the third portion 153 may be configured to press the manifold peripheral edge portion when the position of the manifold peripheral edge portion differs between the first-type fuel cell 10a and the second-type fuel cell 10b. For example, in the above embodiment, the manifold peripheral edge portions are located at both end portions in the longitudinal LD of the first-type fuel cell 10a and the second-type fuel cell 10b. On the other hand, in other embodiments, the manifold peripheral edge portions may be located at both end portions in the lateral SD of the first-type fuel cell 10a and the second-type fuel cell 10b. The third portion 153 may be configured to press the peripheral edge portion of the manifold of the second-type fuel cell 10b instead of the peripheral edge portion of the power generation area of the second-type fuel cell 10b.
(B4) In the above embodiment, the press die 150 includes a detachable attachment and is configured in such a manner that the thickness of the third portion 153 is changeable by attaching or detaching the attachment. On the other hand, in other embodiments, the press die 150 may include a retractable attachment and be configured in such a manner that the thickness of the third portion 153 is changeable by inserting or removing the attachment. Specifically, the press die 150 may be provided with a recess for accommodating an attachment, and the attachment may be configured to be movable up and down by an actuator driven under the control of the control unit 170. The control unit 170 may store the attachment in a recess of the press die 150 when the first-type fuel cell 10a is manufactured, and may protrude the attachment from the recess of the press die 150 when the second-type fuel cell 10b is manufactured. In this case, the thickness of the third portion 153 can be changed more quickly than by changing the thickness of the third portion 153 by attaching or detaching the attachment.

The present disclosure is not limited to the embodiments above, and can be implemented with various configurations without departing from the scope of the present disclosure. For example, the technical features of the embodiments corresponding to the technical features in each mode described in the section of the summary of the disclosure may be replaced or combined appropriately to solve part or all of the above issues or to achieve part or all of the above effects. When the technical features are not described as essential in this specification, the technical features can be deleted as appropriate.

What is claimed is:

1. A fuel cell manufacturing device comprising:
a first press die; and
a second press die configured to press, between the first press die and the second press die, a stack of a fuel cell that includes a membrane electrode assembly, an adhesive, and a separator to bond the membrane electrode assembly and the separator via the adhesive,
wherein either or both of the first press die and the second press die include a first portion and a second portion, the first portion being configured to press a peripheral edge portion of a power generation area of the fuel cell, and the second portion being configured to press a peripheral edge portion of a manifold of the fuel cell.

2. The fuel cell manufacturing device according to claim 1, wherein the first portion and the second portion are thicker than a portion of the stack that includes the power generation area.

3. The fuel cell manufacturing device according to claim 2, wherein either or both of the first press die and the second press die include a third portion that overlaps the power generation area, and are configured in such a manner that a thickness of the third portion is changeable.

4. The fuel cell manufacturing device according to claim 1, wherein the first press die and the second press die are used to preliminarily attach the membrane electrode assembly and the separator together.

5. A fuel cell manufacturing method comprising:
preparing a stack of a fuel cell that includes a membrane electrode assembly, an adhesive, and a separator; and
pressing the stack between a first press die and a second press die to bond the membrane electrode assembly and the separator via the adhesive,
wherein either or both of the first press die and the second press die include a first portion and a second portion, the first portion being configured to press a peripheral edge portion of a power generation area of the fuel cell, and the second portion being configured to press a peripheral edge portion of a manifold of the fuel cell.
